(19) United States
(12) Patent Application Publication
(10) Pub. No.: US 2025/0334411 A1
(43) Pub. Date: Oct. 30, 2025

(54) BALLOON FLIGHT PATH MODELING USING PILOT BALLOON ASCENT DATA FOR ZONE-SPECIFIC WEATHER FORECAST ADJUSTMENTS

(71) Applicant: URBAN SKY, Denver, CO (US)

(72) Inventors: Jared LEIDICH, Denver, CO (US); Stian Dean HOWARD, Boulder, CO (US)

(21) Appl. No.: 19/193,070

(22) Filed: Apr. 29, 2025

Related U.S. Application Data
(60) Provisional application No. 63/639,899, filed on Apr. 29, 2024.

(51) Int. Cl. G01C 21/20; G01W 1/10; G08G 5/76

(52) U.S. Cl. CPC G01C 21/20; G01W 1/10; G08G 5/76

(57) ABSTRACT

A method for accurately modeling a balloon flight path includes obtaining actual ascent data and location data captured by a pilot balloon and using the actual ascent data in combination with forecast data of a plurality of weather models to generate multiple pseudo-predicted flight tracks for the pilot balloon. The method further includes determining an actual flight path of the pilot balloon based on the location data captured by the pilot balloon, identifying, from the multiple pseudo-predicted flight tracks, a best-fit pseudo-track segment that most closely matches a segment of the actual flight path traversing the altitude zone, and quantifying offsets between the best-fit pseudo-track segment and the segment of the actual flight path traversing the altitude zone. The method further includes determining a best-fit weather model of the plurality of weather models, generating an adjusted weather model by shifting predictions of the best-fit weather model by one or more of the offsets, and using the adjusted weather model to predict a future flight path of subsequently launched flight vehicle through the altitude zone.

### CROSS-REFERENCE TO RELATED APPLICATIONS

This application claims priority to U.S. provisional patent application No. 63/639,899 entitled “Regional Fractional Composite Weather Forecast Generation Method Using a Balloon Flight Modeler and a Sounding Balloon” and filed on Apr. 29, 2024, which is hereby incorporated by reference for all that it discloses or teaches.

### BACKGROUND

High-altitude balloons often carry payloads that collect location-sensitive data. Many of these systems include control electronics for initiating and executing ascent and descent maneuvers. However, these systems rely on wind for lateral movement. When using a balloon system to perform a location-specific data collection task, it is critical to be able to accurately model the system's flight path in advance of launch. Flight path modeling is typically performed by flight modeling software that receives, as input, ascent data (e.g., ascent rates) generated by a physics model and weather model data that includes wind forecasts at different altitudes in target flight locations. Consequently, the resulting flight path predictions are highly dependent upon the accuracy of the weather model data that is used.

Traditional weather forecasting methods produce a variety of weather models that cover both global and regional areas. These models are continuously refined to predict atmospheric conditions with varying degrees of accuracy. However, the performance of these weather models can significantly vary based on geographical regions and specific atmospheric conditions, making certain models more suitable for some types of predictions than others. For instance, one weather model may generate wind forecasts that tend to be more reliable at lower altitudes (closer to Earth) than higher altitudes, while another weather model may generate wind forecasts that tend to be more reliable at higher altitudes than lower altitudes.

A common trait of modern weather models is their tendency to exhibit spatial or temporal shifts in their predictions. Rather than being outright incorrect, these models often accurately forecast weather events but misalign them in time or space. For instance, a model might predict a weather event accurately in terms of conditions but project the event to occur thirty minutes earlier than it actually does, or it might forecast the event to take place a kilometer west of its actual location. Broadly speaking, weather forecasts provide weather predictions over a large temporal and spatial domain but lack local, real-time accuracy. This limitation underscores the challenge of relying solely on predictive models for weather forecasting and, specifically, for predicting the flight path of a balloon, as these spatial or temporal discrepancies can significantly affect the reliability of flight path forecasts, especially in applications requiring high precision.

Due to the known inaccuracies in weather model forecasts, an alternative flight path prediction methodology involves launching a pilot balloon—also sometimes referred to as a “sounding balloon”—to capture a snapshot of wind and atmospheric conditions just before launching another balloon system that is to perform location-specific data collection operations. By releasing a pilot balloon and tracking its ascent, meteorologists can obtain valuable data regarding the wind profiles at different altitudes in a single line. This method offers the advantage of gathering real-time, location-specific atmospheric data, providing an immediate understanding of the weather conditions in a particular area.

However, a primary limitation of weather data captured by a pilot balloon is its limited predictive capability. While pilot balloon data can accurately represent wind and weather conditions for a specific line of ascent, pilot balloon data does not provide the temporal and spatial depth that is often required for balloon prediction purposes where the balloon will often not traverse the same space until several hours later. A pilot balloon offers a sequence of data points strung together, forming a line with each point in the line representing the conditions at only one time and place. Alone, this data is insufficient to extrapolate a comprehensive forecast in three spatial dimensions that also extends forward in time (e.g., to the time period in which the flight of interest is to take place). Pilot balloon data becomes less relevant to flight path prediction as time passes and weather conditions change along the ascent line of the pilot balloon. Similarly, pilot balloon data captured from a different launch site, or with a pilot balloon with a different ascent profile causing it to overfly different location than the primary mission balloon, will have reduced value in predicting the flight path of the primary balloon. If, for example, a balloon system is launched four hours after the pilot balloon or from a launch site that is different from the launch site of the pilot balloon, the pilot balloon data may not be relevant or useful in predicting the path that the balloon system will take.

This gap between the real-time local-accuracy of pilot balloon data and the predictive power of comprehensive weather models presents a significant challenge in creating accurate, reliable weather forecasts that are both spatially and temporally relevant in predicting flight paths for balloon systems, particularly stratospheric balloons that perform location-sensitive data collection operations requiring a high degree of precision.

### SUMMARY

According to one implementation, a method for modelling a balloon flight path includes: generating pseudo-predicted flight tracks for a pilot balloon based on actual ascent data captured by the pilot balloon and forecast data of one or more weather model(s); determining the actual flight path of the pilot balloon based on location data captured by the pilot balloon; and selecting segments of the actual flight path corresponding to segments from the pseudo-predicted track within an altitude zone. The method further includes comparing the segments of the actual flight path to various corresponding segments of the pseudo-predicted flight tracks to identify a best-fit pseudo-track segment that most closely matches the segment of the actual flight path, recording offset data that quantifies offsets between the best-fit pseudo-track segment and the segment of the actual flight path corresponding to the altitude zone, generating an adjusted weather model for the altitude zone by applying offsets defined in the offset data to shift predictions of the weather model in space or time; and using the adjusted weather model to predict a first segment of a future flight path for a subsequently launched flight vehicle.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates aspects of an example system for generating a highly accurate weather model for a specific altitude zone in Earth's atmosphere.

FIG. 2 illustrates aspects of an example system that uses pilot balloon ascent data to generate an ensemble weather model that provides a more accurate prediction of wind conditions than presently existing weather models.

FIG. 3 illustrates an example system for modeling a flight path for a flight vehicle using an ensemble weather model generated by the operations described above with respect to FIG. 2.

FIG. 4 illustrates example operations for accurately predicting a balloon system flight path.

### DETAILED DESCRIPTION

The herein-disclosed technology includes a flight modeling system for high-altitude balloons that bridges the gap between currently existing technologies that rely, in the alternative, upon pilot balloon data or comprehensive weather models. As discussed above, pilot balloon data is significantly limited in spatial and temporal precision, while weather forecasting technologies have limited predictive power and frequently exhibit spatial or temporal shifts as compared to actual locations and times of predicted weather events.

The herein-disclosed technology facilitates the generation of highly accurate regional wind forecasts by using actual data collected by a pilot balloon as a basis for estimating temporal and spatial shifts that can be applied to weather model data to improve the space-time alignment between predicted weather events and actual corresponding weather events. According to one implementation, the herein-disclosed methodology entails determining forecast adjustments (e.g., offsets in space and time) to be applied to weather model data, with the adjustments being specific to different altitude ranges, referred to herein as “altitude zones.” The methodology supports exploring the accuracy of different weather models within different altitude zones to identify the most accurate weather model—also referred to herein as the “best-fit weather model”—within each altitude zone and a corresponding set of shifts (e.g., positional, temporal, and rotational shifts) that can be applied to improve the accuracy of wind predictions rendered by that best-fit weather model within the corresponding altitude zone. One result of the foregoing is a highly accurate ensemble weather model that includes wind forecasts specific to different altitude zones, with each zone-specific forecast generated by applying a different set of positional, temporal, and/or rotational shifts to predictions of a weather model that has been identified as the best-fit weather model for that specific altitude zone.

According to one implementation, an ensemble weather model generated using the herein-disclosed technology is used, with high precision, to predict a flight path for a balloon system that is to be launched from the same general location as the pilot balloon used to create the ensemble weather model. This balloon system may, for example, be launched on the same day as the pilot balloon but potentially several hours later. Predicting the flight path for the balloon system entails using the predictions in the ensemble weather model specific to different altitude zones as inputs to construct different segments of a predicted flight path. This methodology may result in a scenario where different base weather models and/or different space-time shifts are input to a flight modeler to generate flight path predictions for different segments of the same flight, yielding a predicted balloon system flight path that is much more accurate than similar predictions generated by currently leading flight modeling technologies.

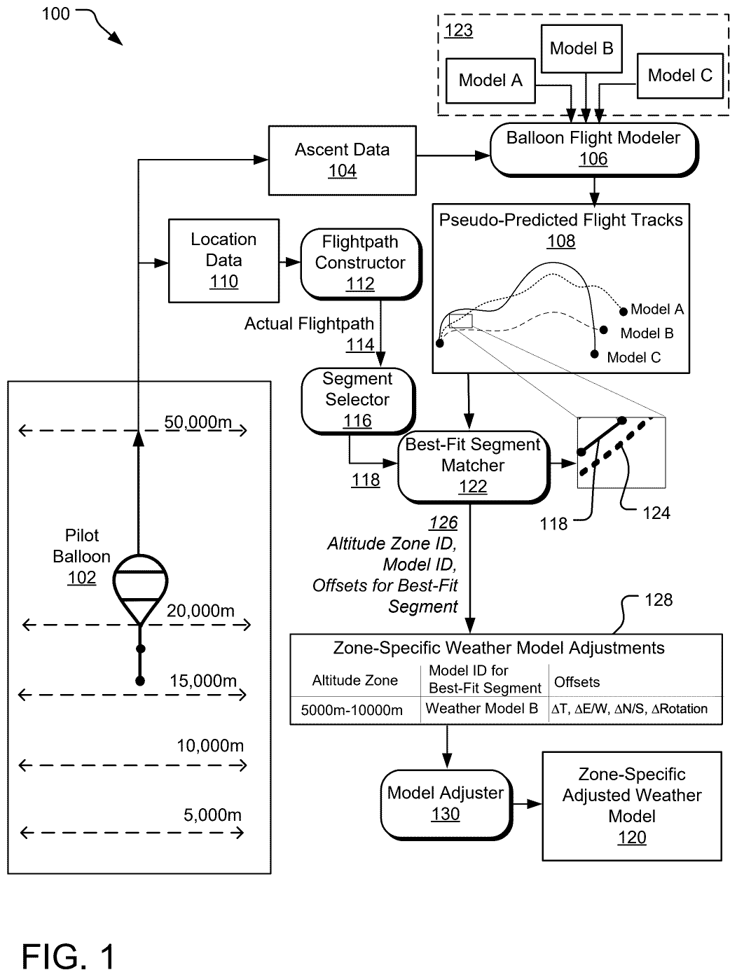

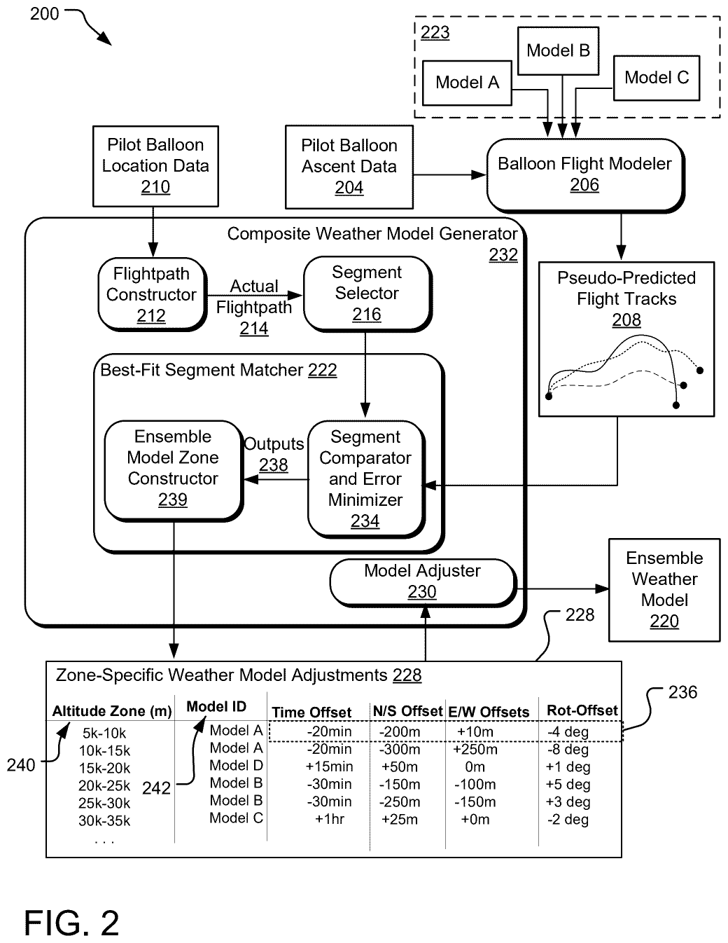

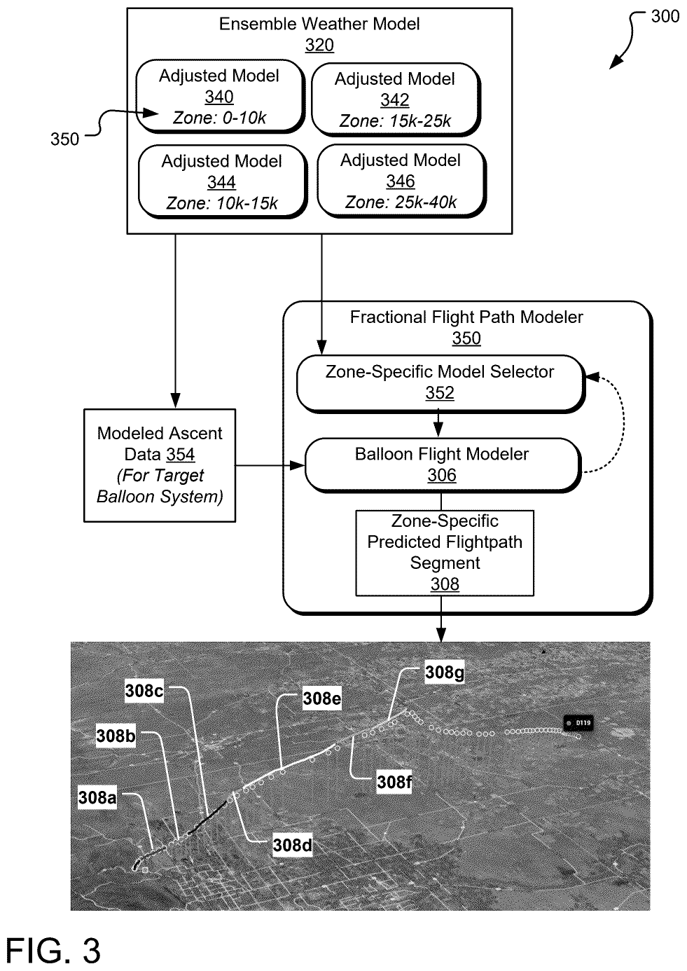

FIG. 1 illustrates aspects of an example system 100 for generating a highly accurate weather model for a specific altitude zone in Earth's atmosphere. This weather model is referenced below and shown in FIG. 1 as “zone-specific adjusted weather model 120.” As is discussed in greater detail with respect to FIG. 2-3, further implementations of the technology provide for generating an ensemble weather model that includes multiple different instances of zone-specific adjusted models that provide forecasts for different respective altitude zones in Earth's atmosphere. For example, an ensemble weather model (not shown in FIG. 1) may include a first instance of the zone-specific adjusted weather model 120 that provides wind predictions at altitudes of 0 to 5000 meters above the Earth's surface, a second different instance of the zone-specific adjusted weather model 120 that provides wind predictions at altitudes of 5000-10000 meters above Earth's surface, a third different instance of the zone-specific adjusted model that provides wind predictions at 10,000-15,0000 meters above Earth's surface, and so on. Operations for building an ensemble weather model are discussed in greater detail with respect to FIGS. 2 and 3.

A process for constructing an instance of the zone-specific adjusted weather model 120 begins with the launch of a pilot balloon 102 from a general geographic area of interest, approximately at the time when a detailed wind forecast is desired for an upcoming time window. For example, the pilot balloon 102 may be launched on the day that a launch is planned for another balloon system that is to conduct location-specific operations, with the pilot balloon 102 being launched several hours (e.g., one hour to six or more hours) before the planned location-sensitive balloon system flight.

The exact timing and location of the launch for the pilot balloon 102 are critically not stringent, offering important flexibility in the application of this method. As the pilot balloon 102 ascends and collects atmospheric data, an algorithmic search for a “best-fit weather model” is conducted, potentially in real-time or near-real time. The pilot balloon 102 collects ascent data 104, which may include altitude measurements (e.g., collected by an altimeter) and corresponding timestamp data usable to derive ascent or descent velocities corresponding to different altitudes. The ascent data 104 is provided as input to a balloon flight modeler 106 (e.g., modeling software), which may be executed by a processing system onboard the pilot balloon 102 or by a ground-based processing system that receives transmissions from the pilot balloon 102.

The balloon flight modeler 106 is a software component that uses the ascent data 104 in combination with wind forecast data of a select weather model (e.g., Model A, Model B, or Model C) to generate a time-series prediction of a flight path (e.g., geographic locations) that the pilot balloon 102 is to follow throughout a period of time corresponding to timestamps included within the ascent data 104.

It is common in the field of high-altitude ballooning to utilize flight path modeling tools, such as the balloon flight modeler 106, when predicting a balloon's flight path. However, in common applications of these flight modeling tools, the ascent data 104 is modeled by a physics engine rather than collected by another balloon system (e.g., the pilot balloon 102). For example, the ascent data 104 is modeled by a physics engine that receives, as input, measured and/or estimated properties of a target balloon system and/or environmental conditions for a particular flight of the target balloon system that is being modeled. The physics of ascent and descent modeling is complex and can depend upon a plethora of factors, including balloon properties (e.g., the volume of the balloon, the shape of the balloon, the mass of the balloon, material properties such as elasticity and strength, the initial temperature of the balloon), gas properties (e.g., the type of lift gas within the balloon, initial pressure and temperature conditions of the lift gas), environmental conditions (e.g., ambient air density, temperature profile, wind speed and direction, atmospheric pressure), forces acting on the balloon (e.g., buoyant force, gravitational force, drag force), payload properties, thermal effects that occur as the balloon ascends and descends, and more.

In these traditional applications of flight path modeling tools, the ascent data that has been modeled for a target balloon system is typically used in combination with weather forecast data of a specific weather model to generate a predicted flight path, which is constructed per the assumption that the specific weather model provides an accurate forecast of the wind conditions that the target balloon is to encounter at various altitudes.

In the system 100, the use of the balloon flight modeler 106 differs from the above-described traditional use of balloon flight modeling tools due to the fact that the ascent data 104 includes actual ascent velocities sampled by the pilot balloon 102 rather than ascent data that has been modeled by a physics engine. The balloon flight modeler 106 is also provided with weather forecast data for each of multiple different weather models 123 (e.g., model A, model B, and model C) and commanded to construct a predicted flight path corresponding to each different weather model provided as an input. In this use case, the balloon flight modeler 106 outputs flight path predictions referred to herein as “Pseudo-Predictive Flight Tracks 108,” with the term “pseudo” intended to signify the fact that the flight tracks are not generated exclusively based on predicted (modeled) inputs, but instead upon some data that is observed (the ascent data 104 for the pilot balloon 102) in combination with predicted weather data.

The different weather models 123 (e.g., Model A, Model B, and Model C) are different source models. Examples of publicly available weather models suitable for this purpose include the National Oceanic and Atmospheric Administration Global Forecast System (NOAA GFS), NOAA High-Resolution Rapid Refresh (NOAA HRRR), Deutscher Wetterdienst Icosahedral Nonhydrostatic model (DWD ICON), European Center for Medium-Range Forecasts Integrated Forecast System (ECMWF IFS), as well as various AI models or other alternative weather models. Commonly, the different weather models 123 provide wind forecasts that differ in at least some aspects relative to one another. Consequently, the corresponding pseudo-predicted flight tracks 108 for the pilot balloon 102 are also different from one another.

In FIG. 1, an illustration of the pseudo-predicted flight tracks 108 is abstracted to a simplified 2D representation of a line (e.g., a flight path); however, each of the pseudo-predicted flight tracks 108 can be understood as a time-series dataset that includes a latitude, longitude, and altitude location of the target balloon system corresponding to a specific point in time.

The next step in generating the zone-specific adjusted weather model 120 includes constructing a dataset representing an actual flight path of the pilot balloon 102 as the balloon ascends and provides the ascent data 104 to the balloon flight modeler 106. In one implementation, the pilot balloon 102 collects location data 110 (e.g., GPS data+altitude data) that is provided to a flight path constructor 112. The flight path constructor 112 transforms the location data 110 into a visual representation of an actual flight path 114 of the pilot balloon 102. For example, the visual representation is a 3D path (including latitude, longitude, and altitude coordinates) that extends forward over a time interval corresponding to at least a portion of the flight of the pilot balloon 102.

Because the pseudo-predicted flight tracks 108 are generated using the same timestamped altitude positions observed for the pilot balloon 102 as the altitude-time data reflected in the actual flight path 114, differences between the actual flight path 114 and the various pseudo-predicted flight tracks 108 are very tightly correlated with differences between predicted wind conditions and actual wind predictions encountered by the balloon system (e.g., with errors in ascent physics being taken out of the equation).

Following the construction of the actual flight path 114 and the pseudo-predicted flight tracks 108 for the different weather models 123, a segment selector 116 selects a segment 118 of the actual flight path 114. In implementations where an ensemble weather model is generated (e.g., as discussed further with respect to FIG. 2-3), the segment selector 116 iteratively selects multiple different segments of the actual flight path 114 that are independently processed per the below-described operations. In various implementations, different criteria may be used to define and select flight path segments (e.g., the selected segment 118). For example, segment selection may be defined based on altitude band of interest (e.g., with each segment corresponding to a predefined altitude range of the actual flight path), time ranges (e.g., using equal time-increments of flight to define each segment), lateral distances, or any other segmenting delineator.

The selected segment 118 is provided, along with the pseudo-predicted flight tracks 108, to a best-fit segment matcher 122. The best-fit segment matcher 122 compares the selected segment 118 of the actual flight path 114 to various segments of the pseudo-predicted flight tracks 108 (e.g., by selecting segments of similar length shifted in space or time) and computing a multi-dimensional error between each pair of segments. The error is, for example, computed in both space and time—e.g., measured as a North/South error, an East/West error, a temporal error, and a rotational error. A multi-dimensional error minimization is performed to identify the pseudo-track segment with the smallest overall error relative to the selected segment of the actual flight path. Multi-dimensional error minimization may, for example, be performed using techniques such as gradient descent, stochastic gradient descent, and least squares optimization, as well as various other optimization algorithms and known techniques.

The objective of this repeated error computation and error minimization operation across different segments of the pseudo-predicted flight tracks 108 is to identify a select segment (e.g., the “best-fit pseudo-track segment 124”) that best aligns with the selected segment 118 of the actual flight path 114 in space and time. The best-fit segment matcher 122 determines that, when compared to the selected segment 118 of the actual flight path 114, the best-fit pseudo-track segment 124 has the smallest total error among all same-length segments of the different pseudo-predicted flight tracks 108. In this particular example, the best-fit pseudo-track segment 124 is a portion of the pseudo-predicted flight track that has been generated based on the wind predictions of Model B. Therefore, Model B is identified as the “best-fit weather model” for the selected segment 118 and the corresponding altitude zone.

Upon identifying the best-fit pseudo-track segment 124, the best-fit segment matcher 122 further identifies temporal and spatial offsets that can be applied to the best-fit pseudo-track segment 124 to shift it into alignment with the selected segment 118 of the actual flight path 114. Notably, these temporal and spatial offsets may be given by reversing the sign of each different error dimension. For example, if the best-fit pseudo-track segment corresponds to a time interval 2 minutes ahead of the selected segment 118, a temporal offset of −2 minutes is needed to shift it back into temporal alignment with the selected segment 118. This −2 minute value is stored as the temporal offset. Similarly, if the selected segment is 300 meters north and 200 east of the selected segment, a north/south offset of −300 meters is stored along with a −200 meter east/west offset (with the negative representing shifts to the south and west). In implementations, the offset computation may also include a rotational shift that suffices to bring the best-fit pseudo-track segment 124 into rotational alignment with the selected segment 118.

Once the best-fit pseudo-track segment 124 has been identified along with temporal and spatial offsets needed to shift the best-fit pseudo-track segment 124 into spatial and temporal alignment with the selected segment 118, the best-fit segment matcher 122 stores output data 126, which includes the identified spatial and temporal offsets, an identifier for the “best-fit weather model” that was used to generate the best-fit pseudo-track segment 124 (e.g., Model B), and an altitude zone identifier that identifies the altitude range of flight corresponding to the selected segment 118. For example, the output data 126 is shown populated within a singular row of a table 128, titled “Zone-Specific Weather Model Adjustments.” Specifically, the illustrated row of the table 128 indicates that “Weather Model B” was identified as the “best-fit weather model” for the observed flight path through an altitude zone of 5000 meter-10,000 meters. The table further indicates the temporal and spatial offsets for the best-fit pseudo-track segment 124.

A model adjuster 130 then uses the information stored in the table to generate the zone-specific adjusted weather model 120 by applying the offsets stored in the row to the wind forecast data of Model B. This adjusted model is “zone-specific” in that it is stored with an identifier indicating it is to be used for forecasting within the associated altitude zone (e.g., 5,000-10,000 meters).

If, for example, the zone-specific adjusted weather model 120 were to be input to the balloon flight modeler 106 along with the ascent data 104 for the pilot balloon 102, the resulting pseudo-predicted flight track 108 would include a segment corresponding to the altitude zone of 5,000 to 10,000 meters that aligns precisely with the selected segment 118 of the actual flight path 114 traversing this same altitude range.

The zone-specific adjusted weather model 120 may then be used as an input for applications that depend upon weather forecast data. For example, this data can now be used to model a flight path for a subsequent balloon flight traversing the same altitude zone. Using the zone-specific adjusted weather model 120 in this manner results in a flight path prediction for the corresponding altitude zone that is significantly more accurate than a flight path predicted rendered using traditional methodologies (e.g., pilot balloon data or weather models without the above-described adjustments).

FIG. 2 illustrates aspects of an example system 200 for generating an ensemble weather model 220 that provides a more accurate prediction of wind conditions than presently existing weather models. The system 200 includes many of the same components described with respect to FIG. 1. Component functionality not specifically described with respect to FIG. 2 may be understood as being the same or similar to that described with respect to like-named components in FIG. 1.

The process for creating the ensemble weather model 220 begins by launching a pilot balloon (not shown) from a geographical location of interest—e.g., an area that is to be subject to data collection operations by the payload of a subsequently launched balloon system. As the pilot balloon ascents, a control system of the pilot balloon collects ascent data (e.g., pilot balloon ascent data 204), which may be understood as including altitude and timestamp readings for sampled data points. Additionally, the pilot balloon collects location data (e.g., pilot balloon location data 210), which may be understood as including GPS data, altitude data, and timestamp readings corresponding to sampled GPS and altitude measurements.

The pilot balloon ascent data 204 is input to a balloon flight modeler 206, along with weather forecast data for various weather models 223. The weather forecast data spans a time period of interest—e.g., a target time period for a subsequent balloon flight, and may, for example include wind forecast data for the next day, three days, seven days, or other time extended forecast period. Based on the wind forecast data of the various weather models 223 and the pilot balloon ascent data 204, the balloon flight modeler 206 models the flight of the pilot balloon according to the predictions of each different one of the various weather models 223. This modeling results in pseudo-predicted flight tracks 208, which include a predicted flight track corresponding to and generated based on each different one of the various weather models 223. For example, each of the pseudo-predicted flight tracks 208 is a time-series dataset, with each time-separated datapoint having a latitude, longitude, and altitude component.

A composite weather model adjuster 232 receives the pseudo-predicted flight tracks 208 as input, along with the pilot balloon location data 210. A flight path constructor 212 constructs an actual flight path 214 taken by the pilot balloon based on the location data 210. The actual flight path 214 is provided in terms of the same dimensions as the pseudo-predicted flight tracks 208—namely, a time-series dataset with each time-separated datapoint having a latitude, longitude, and altitude component.

A segment selector 216 selects a first segment of the actual flight path, and a best-fit segment matcher 222 performs processing operations on the first segment before updating a table 228 with the results of the segment processing (e.g., to include information described with respect to the table 128 of FIG. 1). This process is repeated multiple times for multiple different segments of the actual flight path until the entire path is composed into discrete segments. For example, the segment selector 216 iteratively selects segments that correspond to consecutive equal time intervals of the flight. In another implementation, the segment selector 216 iteratively selects segments that correspond to specific spatial zones (e.g., altitude zones) of the actual flight path.

Upon each iteration of segment selection and segment processing, the best-fit segment matcher 222 executes operations to identify a most similar segment across the pseudo-predicted flight tracks 208. For example, upon selection of a given segment of the actual flight path 214, a segment comparator and error minimizer 234 compares the given segment of the actual flight path 214 to various different equal-length segments within the pseudo-predicted flight tracks 208 and computes spatial and temporal errors for each compared pair of segments (e.g., with the errors representing the temporal and spatial separations between the two segments). The segment comparator and error minimizer 234 performs a multi-dimensional error minimization for each segment pair and, based on this analysis, identifies a “best-match” segment from the pseudo-predicted flight tracks 208 that represents the smallest total spatial and temporal error relative to the fight segment of the actual flight path 214. Consistent with the terminology used in FIG. 1, the description below refers to this best-match segment of the pseudo-predicted flight tracks 208 as the “best-fit pseudo-track segment” for the currently selected segment of the actual flight path. The segment comparator and error minimizer 234 computes a set of spatial and temporal offsets (e.g., offsets 236 shown in table 228) that may be applied to shift the best-fit pseudo-track segment into alignment with the currently selected segment of the actual flight path.

For each selected segment of the actual flight path, segment comparator and error minimizer 234 generates outputs 238 that include a set of the offsets 236, a model identifier 242 for an identified “best-fit weather model” (e.g., an identifier of the weather model used to generate the best-fit pseudo-track segment for the currently-selected flight path segment), and an altitude zone range 240 delineating the altitude range corresponding to the currently-selected segment of the actual flight path 214.

The outputs 238 are provided to an ensemble model zone constructor 239 that compares the outputs 238 to data stored in the row of the table 228 corresponding to the previously-analyzed consecutive flight path segment to determine whether to create a new “zone” of the ensemble weather model 220 or to use an existing (already-defined) zone to provide predictions for the altitude zone range corresponding to the currently-selected flight path segment.

In scenarios where the currently selected segment of the actual flight path 214 is the first-analyzed segment of the actual flight path 214, the table 228 is blank when the ensemble model zone constructor 239 receives the outputs 238 and a new (initial) zone is created by populating a first row of the table 228 with the outputs 238.

However, in an implementation where segments of the actual flight path 214 are analyzed consecutively (e.g., from one end of the flight path to the other), the ensemble model zone constructor 239 may enforce logic that entails evaluating whether the previously generated row in the table 228 (corresponding to the previously-analyzed consecutive flight path segment) provides a sufficiently accurate basis for predicting wind conditions within the altitude zone corresponding to the currently-selected flight path segment. If, for example, the currently selected flight path segment corresponds to an altitude range of 10,000-15,000 meters, the ensemble model zone constructor 239 may determine whether the “best-fit weather model” for the currently selected flight path segment matches the “best-fit weather model” identified for previously analyzed flight path segment corresponding to the altitude range of 5,000-10,000 meters. If so, the ensemble model zone constructor 239 may then evaluate the similarity between the offsets 236 identified for the currently selected flight path segment and the previously analyzed consecutive flight path segment to determine whether the two sets of offsets 236 satisfy similarity criteria. If, for example, the offsets of corresponding dimensions of the offsets are all within a threshold delta of one another, the ensemble model zone constructor 239 may elect to “merge” the altitude ranges together into a single altitude-specific zone of the ensemble weather model 220. In this example, “merging” the altitude ranges of 5,000-10,000 meters and 10,000-15,000 meters into a single altitude-specific zone may entail updating the altitude zone range 240 of the previously-created table row to encompass both altitude zones (e.g., now spanning 5,000-15,0000 meters instead of 5,000-10,000 meters) while leaving other information in the row-namely, the offsets 236 and model identifier 242, unchanged.

Alternatively, the ensemble model zone constructor 239 may elect to create a new altitude zone in the ensemble weather model 220 (and a new row in the table 228) in response to determining that the previously-generated row in the table 228 corresponds to a consecutive flight path segment provides a sufficiently accurate basis for predicting wind conditions within the altitude zone corresponding to the currently-selected flight path segment. Criteria for creating a new altitude zone in the ensemble weather model 220 may differ from one implementation to another.

In one implementation, the ensemble model zone constructor 239 automatically creates a new altitude zone in the ensemble weather model 220 in response to determining that the best-fit weather model for the currently selected flight path segment is different than the best-fit weather model for the consecutive, previously analyzed flight path segment. In another implementation, the ensemble model zone constructor 239 automatically creates a new altitude zone in the ensemble model (and a new row in the table 228) in response to determining that the offsets 236 for the currently selected segment diverge from offsets 236 stored for the previously analyzed consecutive flight path segment by at least a threshold quantity. If, for example, the offset in any singular dimension corresponds to an error exceeding a threshold, a new altitude zone is created in the ensemble weather model 220.

Creating a new altitude zone in the ensemble weather model 220 entails creating and populating a new row of the table 228 with the altitude range corresponding to the currently selected segment, the model identifier for the “best-fit weather model” identified for the currently-selected segments, and offsets applicable to shift the most recently-identified best-fit pseudo-track segment into alignment with the currently-selected flight path segment.

As a result of this process, the table 228 may define altitude zones that are more granular (narrow in range) than altitude bands that are defined for specific individual models of the various weather models 223 provided as input. For example, Weather Model A may have a vertical granularity of 25 hPa (correlating to approximately 0.3-1 km depending on altitude) while the table 228 may include rows corresponding to smaller altitude bands and/or bands of variable size.

After segments of the flight path are processed, per the above-described operations, for each altitude zone of interest, the table 228 is input to a model adjuster 230, which generates different versions of the weather models referenced in the table 228 by applying the offsets stored in each row of the table 228. For example, the model adjuster 230 generates an adjusted version of Model A by applying the offsets stored in the first row of the table 228 to shift the wind predictions of this model. The resulting adjusted (e.g., shifted) version of Model A is then used in future forecasting operations to supply wind data predictions within the altitude zone of 5 k-10 k meters above the Earth's surface. Likewise, the model adjuster 230 generates another (second) adjusted version of Model A by applying the offsets stored in the second row of the table 228. These offsets are then applied to Model A and used, in future forecasting operations, to supply wind data predictions within the altitude zone of 10 k-15 k meters above Earth's surface. In the illustrated example, the model adjuster 230 also generates a shifted version of Model D for the 15 k-20 k meter altitude zone by applying the offsets stored in the third row of the table 228, and so on for each different row.

After creating an adjusted model for each different altitude zone referenced in a different row of the table 228, the resulting adjusted models are stored in association with data identifying the corresponding altitude zones. Collectively, this data represents the ensemble weather model 220.

Notably, the ensemble weather model 220 may encompass locations different from those encountered by the pilot balloon and time periods significantly removed in time (e.g., by several days) as the underlying weather systems remain consistent with those observed during the flight of the pilot balloon. Consequently, the ensemble weather model 220 is a powerful tool for predicting the track of high-altitude balloons. This innovative approach not only enhances the accuracy of wind forecasts, especially in the upper atmosphere where data sources are limited, but also provides a practical solution for generating detailed wind models, thereby offering significant benefits for aerospace, aviation, and other sectors requiring precise meteorological data.

FIG. 3 illustrates an example system 300 for modeling a future flight path for a flight vehicle using an ensemble weather model 320 generated by the operations described above with respect to FIG. 2. In an example use case, the future flight path is modeled for a soon-to-launch balloon system referred to below as the “target balloon system.” The target balloon system is tasked with performing location-sensitive operations, such as location-sensitive data collection operations or location-sensitive data transmission operations. Prior to the operations shown in FIG. 3, a pilot balloon is launched (as generally described with respect to FIG. 1-2), and data from the pilot balloon is used, in combination with weather model data, to construct the ensemble weather model 320. In one implementation, the target balloon system is to be launched from a geographical area that is in the proximity of the launch site of a pilot balloon (e.g., within a few kilometers) and within a few hours and up to a day or so following the launch of the pilot balloon system.

When the below-described ensemble weather model 320 is used to supply the wind predictions to predict a flight path of a subsequently-launched flight vehicle (a target balloon system), the effectiveness of this methodology depends—to some extent—upon the temporal and spatial separations between the launch of the pilot balloon and the launch of the subsequently-launched flight vehicle. Smaller temporal and spatial separations increase the predictive accuracy of the ensemble weather model 320. Although the exact bounds of error are difficult to quantify, it is contemplated that if the pilot balloon is launched from a launch site that is more than a few hundred miles away from the launch site of the subsequently-launched flight vehicle, a global weather model (e.g., publicly available, unshifted model) is may provide a more accurate flight path prediction than the ensemble weather model 320. Likewise, if the pilot balloon is launched more than 12 hours in advance of the future flight path, a global weather model is generally usable to provide a more accurate flight path prediction than the ensemble weather model 320.

The ensemble weather model 320 includes various “adjusted models” (e.g., adjusted models 340, 342, 346, 348, each containing wind forecast predictions of a singular base weather model that have been shifted in space and/or time by a set of offsets determined as described to FIG. 1-2 (e.g., offsets defined within a single row of the table 228 of FIG. 2). Each different one of the adjusted modes 340, 342, 346, and 348 is stored in association with an altitude zone identifier that identifies a corresponding altitude range within Earth's atmosphere that the adjusted model applies to.

To model the future flight path of the target balloon system, the ensemble weather model 320 is provided to a fractional flight path modeler 350. The fractional flight path modeler 350 is a specialized software component configured to select and use the different adjusted models of the ensemble weather model 320 to generate predicted flight paths of the soon-to-launch flight vehicle through the different altitude zones identified in association with each of those adjusted models.

The fractional flight path modeler 350 includes a zone-specific model selector 352 that selects which of the adjusted models 340, 332, 344, and 346 to use when modeling each different flight path segment for the target balloon system. In one implementation, the zone-specific model selector 352 selects the adjusted models 340, 342, 344, and 346 one at a time in order of their corresponding altitude zones to build the “ascent portion” of the future flight path. Then, when building the “descent portion” of the future flight path, the zone-specific model selector 352 selects the same adjusted models in reverse order.

For example, the process begins with the selection of the adjusted model 340, which is used to model the future flight path for the target balloon system through the altitude zone of 0 to 10,000 meters above Earth's surface. The adjusted model 340 is input to a balloon flight modeler 306, which performs operations similar to the balloon flight modelers 106 and 206 of FIGS. 1 and 2, respectively.

In addition to receiving the currently selected adjusted model (adjusted model 340), the balloon flight modeler 306 receives modeled ascent data 354 for the target balloon system. The modeled ascent data 354 is generated by a physics engine that receives, as input, measured and/or estimated properties of the target balloon system, and atmospheric data such as air temperature and pressure from the adjusted forecasts respectively provided by the adjusted models 340, 332, 344, and 346. The modeled ascent data 354 includes estimated ascent velocities corresponding to various altitudes in Earth's atmosphere.

Using the currently selected adjusted model (e.g., the adjusted model 340) and the modeled ascent data 354 corresponding to the altitude zone of the currently selected adjusted model (e.g., 0-10 k meters), the balloon flight modeler 306 generates a zone-specific predicted flight path segment predicted (with different instances of this segment generated for different altitude zones shown as 308a, 308b, 308c, 308d, 308f, and 308g). The first instance 308a of the zone-specific predicted flight path segment 308 traverses the altitude zone of 0-10 k meters.

After generating the first instance 308a of the zone-specific predicted flight path segment 308, the zone-specific model selector 352 selects the next-highest altitude zone corresponding to a (different) adjusted model in the ensemble weather model 320. For example, following the construction of the flight path segment for the altitude range of 0-10 k meters, the zone-specific model selector 352 next selects the adjusted model 344, which corresponds to the altitude range of 10 k-15 k meters. Using this adjusted model and the modeled ascent data 354 corresponding to the altitude zone of 10 k-15 k meters, the balloon flight modeler 306 generates a next instance 308b of the zone-specific predicted flight path segment 308. This process may continue until corresponding predicted flight segments have been constructed for each consecutive portion of the flight path of the target balloon system.

As a result of this process, the complete modeled flight path of the target balloon system consists of consecutive segments (e.g., 308a-308e) that have been generated based on different weather predictions potentially defined by different base weather models and shifted by variable amounts in space and/or time in different altitude zones.

A completed flight generated fractionally, per the above-described operations, is a significantly more accurate representation of the actual flight path of the target balloon system than those predicted by other presently available flight path modeling technologies. This improved flight path prediction capability makes it possible to plan ascent and descent maneuvers for location-sensitive flights at precise points in time to ensure all location-dependent payload objectives are met. If, for example, a balloon system flight is being planned to collect aerial imagery of a target geographical area, the above-described weather modeling and flight prediction techniques make it possible for a flight operator to plan and time ascent and descent maneuvers that allow the balloon system to “catch” target wind streams that laterally drive the balloon system over the areas of interest and/or that cause the balloon system to provide continuous aerial surveillance of a target area for an extended period of time. For instance, this more accurate wind modeling methodology may allow the operator to determine the precise time at which a balloon system is to encounter a predefined geofence perimeter and, with this knowledge, program the balloon system to self-execute a descent maneuver at that precise point that places the balloon system into a lower altitude band with winds that carry the balloon system back toward the interior (e.g., center of) the geofence perimeter.

In one implementation, the fractional flight path modeler 350 includes a maneuver-planning component (not shown) that receives as input geographical constraints for the flight that is being modeled. For example, the maneuver-planning component receives, as input, a geofence perimeter that the balloon system is to always remain within throughout a specific time range. Following the generation of each instance of the zone-specific predicted flight path segment 308, the maneuver-planning component determines whether the predicted segment violates any of the geographical constraints. If so, the maneuver-planning component uses the ensemble weather model 320 to plan an ascent or descent maneuver that may be executed either just prior to or during a predicted flight segment to place the balloon system into a different wind stream to prevent violation of any of the geographical constraints.

For example, the maneuver-planning component may plan an ascent maneuver to auto-execute just moments before the balloon system crosses the geofence boundary, effectively generating new predicted flight segments in a way that ensures the geographical constraint is not violated. For each ascent or descent maneuver planned in this way, the maneuver-planning component may provide the balloon flight modeler 306 with a projected maneuver end time and post-maneuver altitude. In response, the balloon flight modeler 306 may instruct the zone-specific model selector 352 to select the appropriate adjusted model (e.g., 340, 342, 344, 36) to predict the next flight segment of the balloon system that begins at the post-maneuver altitude. Thus, the maneuver-planning component, balloon flight modeler 306, and zone-specific model selector 352 may work together in this manner to predictively plan a flight for a target balloon system that complies with defined geographical constraints.

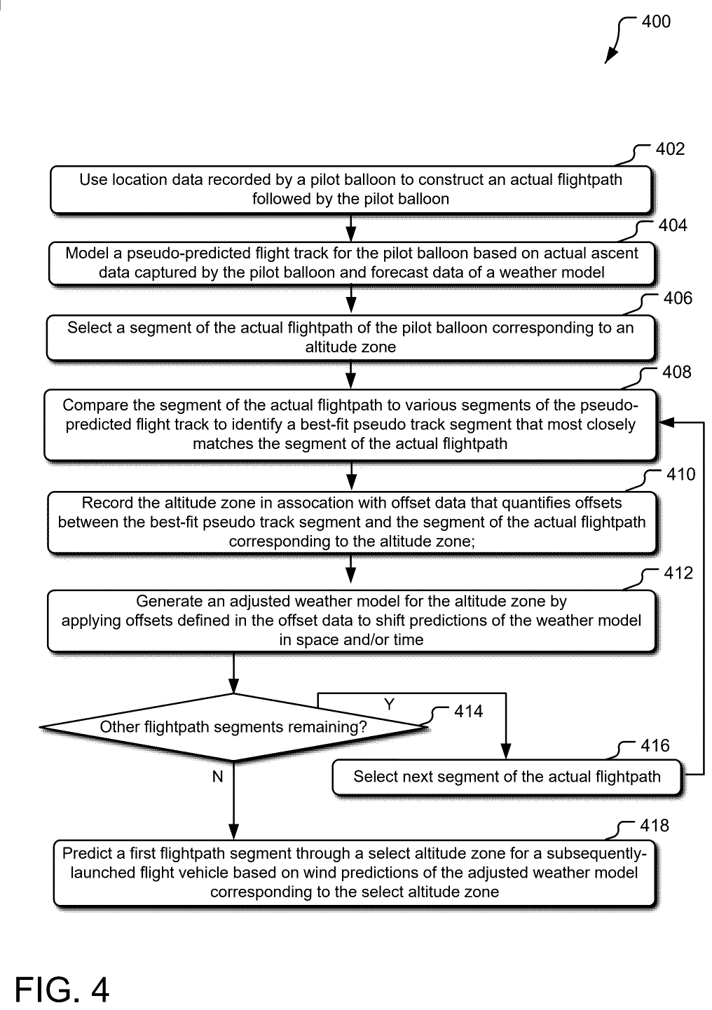

FIG. 4 illustrates example operations 400 for accurately predicting a balloon system flight path. Prior to initializing the operations 400, a pilot balloon is launched from a geographical location of interest for a subsequent balloon system flight. The subsequent balloon system flight is, for example, a future flight for a balloon system that is tasked with performing location-sensitive data collection operations that depend upon the precise positioning of the balloon system within a geographical area or along a particular predefined flight path. The operations 400 may be performed dynamically, either by software executed onboard the balloon system or by other processing system that receives ascent data and location data from the pilot balloon.

A flight path construction operation 402 uses actual location data recorded by the pilot balloon to reconstruct an actual flight path taken by the pilot balloon. For example, the actual location data includes GPS coordinates and altimeter readings sampled at a series of time-separated points during the flight of the pilot balloon.

A modeling operation 304 constructs a pseudo-predicted flight track for the pilot balloon. The pseudo-predicted flight track is referred to as “pseudo-predicted” because it is based on some data that predicted—namely, forecast data of a weather model—and some data that has been observed/measured during the actual flight of the pilot balloon—specifically, ascent data which includes altimeter readings and corresponding timestamps recorded during flight and/or ascent velocities derived from such. In some implementations, multiple pseudo-predicted flight tracks are generated by the modeling operation 304, with each different one of the pseudo-predicted flight tracks being generated based on the wind forecast data of a different weather model.

A selection operation 406 selects a segment of the actual flight path corresponding to a specific altitude range (“altitude zone”). In different implementations, the segment may be selected based on different types of segment delimiters. For example, the segment may correspond to a portion of the flight that is of a set temporal length, or that traverses a specific distance laterally. In an example implementation, the selection operation 406 selects the first portion of the actual flight path describing the ascent of the pilot balloon from the Earth's surface (e.g., launch time from an altitude of 0 meters) to a subsequent point in time coinciding with a first instance of a specific type of segment delimiter (e.g., set time interval, set altitude range).

A comparison operation 408 compares the segment of the actual flight path to various segments of the pseudo-predicted flight track to identify a best-fit pseudo-track segment (e.g., a portion of the pseudo-predicted flight track) that most closely matches the segment of the actual flight path. In one implementation, the best-fit pseudo-track segment and the segment of the actual flight path have equal lengths corresponding to equal-length time intervals. In implementations where the modeling operation 404 models multiple pseudo-predicted flight track segments for different weather models, the comparison operation 410 entails comparing the segment of the actual flight path to multiple segments within each of the multiple different pseudo-predicted flight tracks and also determining spatial and temporal offsets between the segment of the actual flight path and each pseudo-predicted flight track segment that it is compared to.

A recordation operation 410 records the altitude zone spanned by the segment of the actual flight path in association with offset data that quantifies offsets (e.g., temporal and/or spatial offsets) between the best-fit pseudo-track segment and the segment of the actual flight path. In implementations where multiple weather models are used to generate multiple pseudo-predicted flight tracks during the modeling operation 404, the recordation operation 410 further provides for recording the offset data in association with an identifier of a select one of the multiple weather models (e.g., the “best-fit weather model” as described elsewhere herein) that was used to generate the identified best-fit pseudo-track segment. Aspects of the comparison operation 408 and recordation operation 410 not explicitly described with respect to FIG. 4 may be the same or similar to operations described with respect to the best-fit segment matchers 122 and 222 in FIGS. 1 and 2, respectively.

A model generation operation 412 generates an adjusted weather model by adjusting the weather model used to create the best-fit pseudo-track segment based on the offset data stored in association with the altitude zone corresponding to the selected segment of the actual flight path. Specifically, temporal and/or spatial offsets defined in the offset data are applied to shift the forecast predictions (e.g., wind predictions) of the best-fit weather model in space and/or in time. This adjusted weather model is stored in association with an altitude zone identifier that identifies the altitude zone of the selected segment of the actual flight path, and the adjusted weather model is subsequently used (e.g., by various instances of a prediction operation 420) to predict flight path segments of balloon vehicles that traverse portions of the altitude zone.

A determination operation 414 determines whether there exist other segments of the actual flight path of the pilot balloon that extend outside the altitude zone pertaining to the currently selected segment. If so, another selection operation 416 selects a new segment of the pilot balloon's actual flight path. This newly selected segment is, potentially, the next consecutive segment following the last-selected segment.

Following the selection of the next segment of the actual flight path, the comparison operation 408 is repeated (e.g., comparing the newly-selected segment to various segments of one or more pseudo-predicted flight paths), followed by another instance of the recordation operation 410 (e.g., to record the offset data for the identified best-fit pseudo segment), and the model adjustment operation 412 (e.g., to adjust an instance of the best-fit weather model by the offset data). In some implementations, the model adjustment operation 412 is optionally performed for all segments following the initially selected flight segment. If, for example, the offset data for the newly selected segment is sufficiently similar to offset data recorded in association with the previously selected segment of the actual flight path, a new adjusted weather model may not be generated. Instead, metadata for the previously generated adjusted weather model may be updated to reflect the fact that the adjusted model can be used for altitude zones corresponding to the currently selected segment as well as the last-selected segments. These example operations are described in more detail with respect to FIG. 2.

Once the determination operation 414 determines that all segments of the pilot balloon's flight path have been selected and analyzed as described above, a flight path prediction operation 418 predicts a flight path segment for a subsequently launched flight vehicle, such as another balloon system launched from the same or similar launch site as the pilot balloon at a time shortly following (e.g., a few hours after) the pilot balloon launch. The prediction operation 418 predicts the flight path of the subsequently launched flight vehicle along one or more segments that extend through one or more altitude zones corresponding to altitude zone(s) stored in association with adjusted weather model(s) created during one or more instances of the model adjustment operation 412. Predicting the flight path for the subsequently launched vehicle through a select altitude zone entails retrieving the adjusted weather model for that zone and providing that adjusted weather model, along with modeled ascent data for the subsequently launched balloon system, to balloon flight modeling software that uses weather forecast data and the modeled ascent data to generate a corresponding flight path prediction. This process can be repeated for each different segment of the future flight path extending through a different altitude zone.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

The above specification, examples, and data, together with the attached appendices, provide a complete description of the structure and use of example implementations.

What is claimed is:

1. A balloon flight path modeling system comprising:
memory;
a processing system;
computer-executable instructions stored in memory and executable by the processing system to:
generate a pseudo-predicted flight track for a pilot balloon based on actual ascent data captured by the pilot balloon and forecast data of a weather model;
determine actual flight path of the pilot balloon based on location data captured by the pilot balloon;
select a segment of the actual flight path corresponding to an altitude zone;
compare the segment of the actual flight path to various segments of the pseudo-predicted flight track to identify a best-fit pseudo-track segment that most closely matches the segment of the actual flight path, the best-fit pseudo-track segment representing a portion of the pseudo-predicted flight track;
record offset data that quantifies offsets between the best-fit pseudo-track segment and the segment of the actual flight path;
generate an adjusted weather model for the altitude zone by applying offsets defined in the offset data to shift predictions of the weather model in space or time; and
use the adjusted weather model to predict a first segment of a future flight path a subsequently launched flight vehicle, the first segment traversing at least a portion of the altitude zone.

2. The balloon flight path modeling system of claim 1, wherein the best-fit pseudo-track segment minimizes spatial and temporal offsets with the selected segment.

3. The balloon flight path modeling system of claim 1 wherein the computer-executable instructions are further executable to:
generate multiple pseudo-predicted flight tracks for the pilot balloon based on the actual ascent data captured by the pilot balloon and forecast data of a plurality of different weather models, each of the multiple pseudo-predicted flight tracks representing a predicted path of the pilot balloon assuming actual wind conditions local to the pilot balloon match conditions predicted by a corresponding one of the plurality of different weather models;
compare the segment of the actual flight path to multiple segments within the multiple pseudo-predicted flight tracks; and
determine spatial and temporal offsets between the segment of the actual flight path and each of the multiple segments within the multiple pseudo-predicted flight tracks, wherein the best-fit pseudo-track segment for the altitude zone minimizes the spatial and temporal offsets.

4. The balloon flight path modeling system of claim 3, wherein the computer-executable instructions further include zone-specific weather forecasting and flight modeling operations including:
selecting a new segment of the actual flight path corresponding to a new altitude zone;
identifying, from the multiple pseudo-predicted flight tracks, a new best-fit pseudo-track segment that most closely matches the new segment of the actual flight path;
recording the new altitude zone in association with data identifying both a best-fit weather model used to generate the new best-fit pseudo-track segment and new offset data quantifying offsets between the new best-fit pseudo-track segment and the new segment of the actual flight path;
generating a new adjusted weather model for the new altitude zone by applying offsets defined in the new offset data to predictions of the best-fit weather model;
using the new adjusted weather model predict a segment of the future flight path for the subsequently launched flight vehicle through the new altitude zone; and
repeat the zone-specific weather forecasting and flight modeling operations multiple times to model multiple consecutive segments of the future flight path for the subsequently launched flight vehicle.

5. The balloon flight path modeling system of claim 4, wherein the offset data quantifies a temporal offset, a spatial offset, and a rotational offset and wherein generating the new adjusted weather model includes shifting wind predictions of the best-fit weather model by the temporal offset, the spatial offset, and the rotational offset.

6. The balloon flight path modeling system of claim 1, wherein the future flight path originates at a launch location less than one hundred miles from a launch location of the pilot balloon and the future flight path is predicted to occur with twelve hours of collecting the location data and ascent data for the pilot balloon.

7. A method comprising operations for predicting a flight path of a balloon system through an altitude zone, the operations comprising:
obtaining actual ascent data and location data captured by a pilot balloon;
using the actual ascent data in combination with forecast data of a plurality of weather models to generate multiple pseudo-predicted flight tracks for the pilot balloon, each of the multiple pseudo-predicted flight tracks representing a predicted path of the pilot balloon assuming actual wind conditions local to the pilot balloon match conditions that are predicted by a corresponding one of the plurality of weather models;
determining an actual flight path of the pilot balloon based on the location data captured by the pilot balloon;
create an ensemble weather model that uses different weather models selected from the plurality of weather models to predict conditions in different altitude zones overlying a same geographic location, wherein creating the ensemble weather model entails repeatedly performing model update operations that include:
selecting a segment of the actual flight path corresponding to an altitude zone;
identifying, from the multiple pseudo-predicted flight tracks, a best-fit pseudo-track segment that most closely matches the selected segment of the actual flight path;
identifying from the plurality of weather models, a best fit model that was used to generate the best-fit pseudo-track segment; and
define a new altitude zone in the ensemble weather model, the new altitude zone having a zone identifier corresponding to the selected segment that is stored in association with an identifier for the best-fit weather model;
following repeated instances of the model update operations that collectively create a plurality of altitude zones in the ensemble weather model, use the ensemble weather model to predict multiple segments of a future flight path of a target balloon system, each of the multiple segments of the future flight path traversing a different altitude zone of the plurality of altitude zones and being predicted based, at least in part, on a wind forecast given by the best-fit weather model that is stored for the different altitude zone.

8. The method of claim 7, further comprising:
determining offset data that quantifies offsets between the best-fit pseudo-track segment and the selected segment of the actual flight path traversing the altitude zone, wherein the offset data in association with the zone identifier for the new altitude zone.

9. The method of claim 8, wherein using the ensemble weather model to predict a first flight segment of the future flight path includes:
determining a first altitude zone of the plurality of altitude zones corresponding to the first flight segment;
retrieving an identifier of the best-fit weather model that is stored for the first altitude zone;
retrieving the offset data that is stored for the first altitude zone;
generating an adjusted model for the first altitude zone by adjusting the wind predictions of the best-fit weather model by the offset data;
using the adjusted model to predict the first flight segment.

10. The method of claim 7, wherein identifying the best-fit pseudo-track segment further in each iteration of the model update operations comprises:
comparing the selected segment of the actual flight path through the altitude zone to multiple segments within each of the multiple pseudo-predicted flight tracks; and
determining spatial and temporal offsets between the segment of the actual flight path and each of the multiple segments within the multiple pseudo-predicted flight tracks, wherein the best-fit pseudo-track segment for the altitude zone minimizes the spatial and temporal offsets.

11. The method of claim 8, further comprising:
for each instance of the model update operations, creating a new row within a table, the new row identifying:
the zone identifier corresponding to the selected segment;
the best-fit weather model used to generate the best-fit pseudo-track segment for the selected segment; and
the offset data quantifying offsets between the best-fit pseudo-track segment and the selected segment of the actual flight path, wherein using the ensemble weather model to predict multiple segments of the future flight path includes constructing the predicted flight path as a plurality of consecutive segments respectively generated based on the offset data and the best-fit weather model stored in different rows in the table.

12. The method of claim 11, wherein constructing a first segment of the plurality of consecutive segments includes:
determining a first altitude zone corresponding to the first segment;
determining, from the table, the best-fit weather model identified in association with the first altitude zone;
determining an adjusted weather model for the first altitude zone by adjusting wind predictions of the weather model by offsets identified in the offset data stored in association with the first altitude zone; and
using the adjusted weather model for the first altitude zone, in combination with an ascent model generated for the target balloon system, to forecast a flight of the target balloon system through the first altitude zone.

13. The method of claim 7, wherein the future flight path originates at a launch location less than one hundred miles from a launch location of the pilot balloon and the future flight path is predicted to occur with twelve hours of collecting the location data and ascent data for the pilot balloon.

14. A method comprising:
obtaining actual ascent data and location data captured by a pilot balloon;
using the actual ascent data in combination with forecast data of a plurality of weather models to generate multiple pseudo-predicted flight tracks for the pilot balloon, each of the multiple pseudo-predicted flight tracks representing a predicted path of the pilot balloon assuming actual wind conditions local to the pilot balloon match conditions that are predicted by a corresponding one of the plurality of weather models;
determining an actual flight path of the pilot balloon based on the location data captured by the pilot balloon;
repeatedly performing zone-specific model adjustment operations that include:
selecting a segment of the actual flight path corresponding to a select altitude zone;
identifying, from the multiple pseudo-predicted flight tracks, a best-fit pseudo-track segment that most closely matches the segment of the actual flight path;
determining offset data that quantifies offsets between the best-fit pseudo-track segment and the segment of the actual flight path corresponding to the select altitude zone;
determining a best-fit weather model of the plurality of weather models, the best-fit weather model having served as a basis for generating the best-fit pseudo-track segment;
defining a zone-specific weather model adjustment that identifies the select altitude zone, the offset data, and an identifier for the best-fit weather model;
generating a plurality of zone-specific adjusted weather models corresponding to instances of the zone-specific weather model adjustment, each zone-specific adjusted weather model of the plurality of zone-specific adjusted weather models being generated by shifting forecast data of the best-fit weather model defined by a select one of the instances based on offsets defined in the offset data for the select one of the instances; and
storing the plurality of zone-specific adjusted weather models as an ensemble weather model.

15. The method of claim 14, further comprising:
receiving modeled ascent data for a target balloon system;
predicting multiple different flight segments of a future flight of the target balloon system, wherein predicting each flight segment of the multiple different flight segments includes:
determining a select altitude zone to be traversed by the target balloon system during the flight segment;
identifying a select adjusted model of the plurality of zone-specific adjusted weather models corresponding to the select altitude zone; and
using the modeled ascent data in combination with the select adjusted model to generate the flight segment.

16. The method of claim 15, further comprising:
planning an altitude maneuver for the target balloon system in response to determining that the flight segment crosses a predefined geofence perimeter, the altitude maneuver designed to ensure the target balloon system remains internal to the predefined geofence perimeter.

17. The method of claim 15, wherein identifying the best-fit pseudo-track segment further comprises:
comparing the segment of the actual flight path through the select altitude zone to multiple segments within each of the multiple pseudo-predicted flight tracks; and
determining spatial and temporal offsets between the segment of the actual flight path and each of the multiple segments within the multiple pseudo-predicted flight tracks, wherein the best-fit pseudo-track segment for the select altitude zone minimizes the spatial and temporal offsets.

18. The method of claim 15, further comprising:
predicting different segments of a flight path for a target balloon system through different altitude zones based, at least in part, upon wind predictions given by a subset of the plurality of zone-specific adjusted weather models corresponding to the different altitude zones.

19. The method of claim 15, wherein the offset data quantifies a temporal offset, a spatial offset, and a rotational offset and wherein shifting the forecast data based on the offsets includes shifting the forecast data of the best-fit weather model by the temporal offset, the spatial offset, and the rotational offset.

20. The method of claim 15, wherein the future flight path originates at a launch location less than one hundred miles from a launch location of the pilot balloon and the future flight path is predicted to occur with twelve hours of collecting the location data and ascent data for the pilot balloon.
